(19) United States
(12) Patent Application Publication
(10) Pub. No.: US 2012/0055057 A1
(43) Pub. Date: Mar. 8, 2012

(54) Announcement device

(76) Inventor: Scott M. Joffe, Austin, TX (US)

(21) Appl. No.: 13/200,874

(22) Filed: Oct. 4, 2011

Related U.S. Application Data
(63) Continuation-in-part of application No. 12/228,596, filed on Aug. 14, 2008, now abandoned.

(51) Int. Cl. G09F 7/12

(52) U.S. Cl. 40/594

(57) ABSTRACT

The present invention relates to an announcement device that incorporates a set of indicia that incorporates raised, custom graphics and text having a generally metallic appearance with a satin, a polished, or a highly polished surface finish. The set of indicia includes an adhesive backing for mounting onto paper, cardstock, and solid materials like Plexiglas®, wood, stone, and metal. The raised, metallic graphics provide a vivid visual image of reflected metal, and the difference in height between the raised metallic graphics and the mounting surface provide a unique tactile characteristic without the use of typical embossing, debossing, or foil application techniques. The set of indicia can include pictorial graphics, text, images, communicating marks, or illustrative marks that communicate information related to events like weddings, social events, religious events, business applications, or family events.

### CROSS REFERENCE TO RELATED APPLICATIONS

This application claims the benefit of U.S. Nonprovisional application Ser. No. 12/228,596 filed on Aug. 14, 2008. The entire disclosure of that application is incorporated by reference into the disclosure of this document is if fully stated herein.

### STATEMENT REGARDING FEDERALLY SPONSORED RESEARCH

Not Applicable.

### BACKGROUND OF THE INVENTION

There are many social, religious, and business occasions where special announcements are prepared and provided to various individuals and entities. For example, wedding invitations are usually sent to the friends of the bride and groom to signal the time and date of a wedding. In other instances, announcements are sent to potential guests for social and religious events such as birthdays, holidays, and the announcement of births within a family.

In the business world there are also a number of business activities that often indicate the use of announcements. For example, the formation of a new business, the relocation of an existing business, the notice that a new partner has joined a firm, or even the announcement that a new product is being introduced into a new market are events for which announcements and greeting cards can, and are, usually used.

In each of the above events, whether family, social, religious, or business, there is normally a desire to send an announcement that is unique and special in appearance and content. In the past, such announcements have included the use of formal engraved lettering, high quality printing processes, letterpresses, embossing, and debossing that can be placed upon special high quality paper. In other instances, the use of metal foil as the medium has been used to generate decorative and festive types of announcements. Additionally, when foil has been used in the past, it has virtually always been applied only to paper or cardstock and never on such materials as Plexiglass®, plastic, wood, metal, or leather. Also, when foil has been used in the past, it has virtually always been applied only to embossed or debossed paper or cardstock. In yet other instances, cards and papers having special cutouts and folds are often used to generate attractive and unusual forms of announcements that are interesting to read and which denote the proper amount of emotion to be evoked by the announcement.

Although social and family announcements usually involve the use of greeting cards, there are other occasions where alternative types of announcements are often used as communication devices. For example, when businesses wish to communicate specific types of information about their products or services, businesses can provide calendars, business cards, and other types of marketing material. In other circumstances regarding such activities as charitable events or award ceremonies, the announcement and even the actual certificates of award, are generally made in a manner that is out of the ordinary and that have special appearance attributes—with the more unusual appearance attributes being the most preferable. As in the case of the announcements noted above, those other types of communication devices can also include the use of materials, paper, and graphics that are eye-catching and attractive.

Thus, in virtually every type of instance where an announcement of some type is prepared and communicated, it is important to generate an announcement that is unique, interesting, attractive, and in tune with the communication being made.

### SUMMARY OF THE INVENTION

The various embodiments of the present invention include configurations of a unique, interesting, and attractive announcement device that incorporates raised, solid metal custom graphics and text that can have a polished, mirror-like surface that include an adhesive backing for mounting onto paper, cardstock, and solid materials like Plexiglas®, wood, stone, and metal. The raised, solid metal graphics not only provide a vivid visual image of reflected metal, the difference in height between the raised solid metal graphics and the media onto which the graphics are mounted provide a unique tactile characteristic to the announcement device without the use of typical embossing techniques, debossing techniques, or general printing processes. Additionally, the unique characteristics of certain embodiments of the present invention allow for the inclusion of metal and polished metal indicia on surfaces such as those described above that cannot otherwise accept embossed foil stamping to generate the metallic effect of embodiments of the present invention.

Embodiments of the present invention also include the use of satin surfaces, generally polished surfaces, and extremely high quality polished surfaces to generate metallic lettering, complex pictorial graphics, images, logos, etc. that can be placed on a surface of a medium or substrate to generate a wide variety of announcements. The result is a new and exceptionally unique announcement that includes not only extremely high quality metallic lettering, but also pictorial graphics, images, logos, etc. that can be placed on a surface of a medium or substrate to generate a wide variety of announcements that are particularly attractive and that convey the special importance of the event identified within the announcement.

The preferred embodiments of the present invention include a unique type of announcement that does not use any type of printing technique, but instead incorporates a thin layer of either polished or unpolished metal in the shape of graphics and text that generate an announcement device with both vivid visual image and which provides a unique tactile feel resulting from the raised surfaces of the metal graphics and text that are substantially different from typical engraved or foil embossed announcements.

### DESCRIPTION OF THE DRAWINGS

In the accompanying drawings which form part of the specification:

FIG. 1 is a front perspective view of one embodiment of the present invention; and,

FIG. 2 is a section view of one embodiment of the present invention.

Corresponding reference characters indicate corresponding parts throughout the several views of the drawings.

While embodiments of the present invention are illustrated in the above referenced drawings and in the following descriptions, it is understood that the embodiments shown are merely for purpose of illustration and that various changes in construction may be resorted to in the course of manufacture in order that the present invention may be utilized to fit the circumstances which may arise, without in any way departing from the spirit and intention of the present invention, which is to be limited only in accordance with the claims contained herein.

### DETAILED DESCRIPTION OF ONE PREFERRED EMBODIMENT

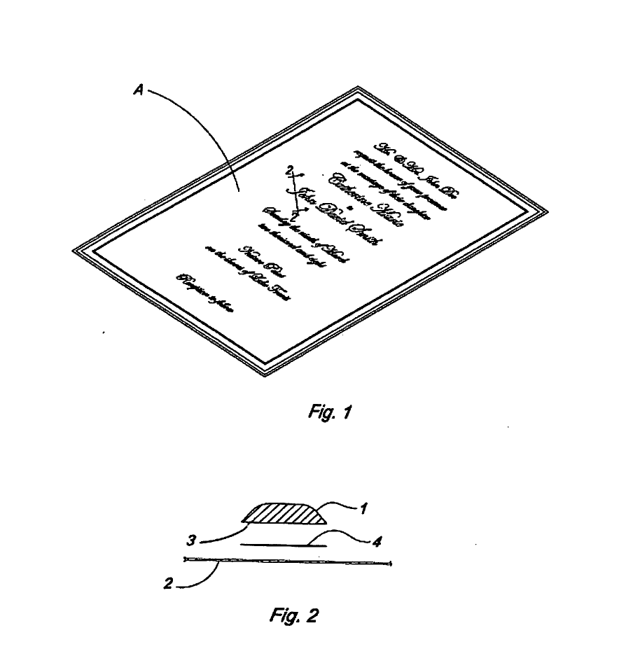

Referring now to FIG. 1, the present invention relates to an announcement device A, and more specifically to an announcement device that comprises a set of indicia 1 that has been placed on a mounting surface 2. The indicia 1 can be any type of text, image, graphic, or other communicating or illustrative mark. The mounting surface 2 can be of any type material as long as the mounting surface is capable of allowing the set of indicia 1 to be properly mounted onto the mounting surface. For example, the mounting surface can be made of paper, cardstock, plastic stock, wood stock, metal, or leather.

It is understood that the set of marking indicia 1 has pertinent information related to at least one of either a wedding, a social event, a religious event, a business application, or a family event. In alternative embodiments, embodiments of the present invention may also be used to transmit general information such as business cards or advertising data. Depending upon the alternative embodiment of the present invention that is used, exemplary information in the set of indicia 1 may include wedding invitations that are usually sent to the friends of the bride and groom to signal the time and date of a wedding. In other instances, announcements are sent to potential guests for social and religious events such as birthdays, holidays, and the announcement of births within a family.

In yet other alternative embodiments of the present invention, the set of indicia 1 can include information related to business applications such as business cards, the formation of a new business, the relocation of an existing business, the notice that a new partner has joined a firm, or even the announcement that a new product is being introduced into a new market, all of which are events for which announcements and greeting cards can, and are, usually used.

It is understood that regardless of the type of event for which the announcement A is being used, the set of indicia 1 will always include the pertinent information as dictated by the user of the announcement A that properly relates to the event and will include any additional information that the announcer wishes to include.

In one preferred embodiment of the present invention, the announcement device A is a wedding invitation. As such, the set of indicia 1 includes information such as the names of the bride and groom, the place the wedding will take place, the place the reception will take place, and the time and date of the wedding and the reception. The invitation can also include other information such as directions to the wedding and reception, or the manner in which potential guests must signal their intent to attend the events described on the wedding invitation.

In the present embodiment, the set of indicia 1 is mounted to the mounting surface 2 as shown in FIG. 2. The indicia 1 has a back surface 3. In this preferred embodiment, an adhesive 4 is applied to the back surface 3 to allow the indicia 1 to be applied to the mounting surface 2.

The set of indicia 1 in a preferred embodiment is generally made from a metal material that is capable of being displayed as a metallic, polished, or highly polished metal surface. In some embodiments, the set of indicia can be made from solid metal while in alternative embodiments, the set of indicia may be made of metal, but the metal need not be solid. For example, the set of indicia may be in the form of a hollow metal indicia in which at least a portion of the internal area of the indicia does not include metal and may include other material or even be filled with air. It is understood that whatever design is elected, the set of indicia will either be made of metal or a material that simulates the appearance of a metal surface.

In some preferred embodiments, the set of indicia 1 has a very highly polished surface such that the metallic appearing surfaces of the set of indicia are mirror-like. In other embodiments, the set of indicia 1 is generally metallic in appearance, but is not mirror-like, but is instead has a generally polished metal appearance. In yet other embodiments, the set of indicia 1 does not have a polished appearance, but instead has a satin finish.

In a preferred embodiment the set of indicia 1 has a combined metal and adhesive thickness of between about 0.06 mm and about 0.12 mm. In alternative embodiments, the metallic portion only of the set of indicia 1 has a thickness of between about 0.06 mm and about 0.12 mm. It will be appreciated by those of skill in the art that the thickness of the set of indicia 1 can be modified and adjusted as necessary to meet the particular application in which embodiments of the present invention are sued and still remain within the intended scope of the claims of the invention.

It will also be appreciated by those of skill in the art that the set of indicia 1 is placed onto the mounting surface 2 as required to meet the design of the present embodiment that is preferred for a specific application. For example, when the set of indicia 1 substantially includes text and numbers, the location of the set of indicia on the mounting surface 2 should be properly aligned as needed to provide for proper alignment of the text and numbers to transmit the particular announcement being offered. In yet other embodiments wherein the set of indicia 1 substantially includes images that do not include text and numbers, the set of indicia is aligned with registration points identified on the mounting surface 2. This type of alignment is particularly useful when the set of indicia 1 includes images and logos for such products as business cards, letterhead, and advertisements.

In substantially automated manufacture of one embodiment of the present invention, mechanical stops, optical alignment tools, or other such devices may be used to sufficiently align the set of indicia 1 with the mounting surface 2 to ensure proper alignment of the set of indicia onto the mounting surface.

The adhesive 4 can be of any well-known binding material with the exceptions that the adhesive selected must retain the set of indicia 1 onto the mounting surface 2 such that the packaging, shipping, transporting, and using of the announcement device A does not result in the separation of any portion of the set of indicia from the mounting surface to which the set of indicia has been mounted, and that the adhesive selected should not become substantially discolored during the time that the announcement device is in use.

While the above description describes various embodiments of the present invention, it will be clear that the present invention may be otherwise easily adapted to fit any configuration where an announcement device is required. Additionally, as various changes could be made in the above constructions without departing from the scope of the invention, it is also intended that all matter contained in the above description or shown in the accompanying drawings shall be interpreted as illustrative and not in a limiting sense. The scope of the invention should be determined by the appended claims and their legal equivalents, rather than by the examples given.

What is claimed is:

1. An announcement device comprising:
a set of indicia that has a metallic appearance and a thickness between about 0.06 mm and about 0.12 mm;
an adhesive applied to a back surface of the set of indicia; and
a mounting material that is not one of either embossed or debossed upon which the set of indicia is mounted to generate an announcement device.

2. The announcement device of claim 1 wherein the set of indicia includes at least one of either pictorial graphics, text, images, communicating marks, or illustrative marks.

3. The announcement device of claim 2 wherein the set of indicia has information related to at least one of either a wedding, a social event, a religious event, a business application, or a family event.

4. The announcement device of claim 3 wherein the mounting material is made from a material selected from the group consisting of paper, cardstock, plastic stock, wood stock, metal, and leather.

5. The announcement device of claim 4 wherein at least one component of the set of indicia is a solid metal material.

6. The announcement device of claim 4 wherein at least one component of the set of indicia is not a solid metal material.

7. An announcement device comprising:
a set of indicia that includes at least one of either pictorial graphics, text, images, communicating marks, or illustrative marks, and wherein the set of indicia has a metallic appearance and a thickness between about 0.06 mm and about 0.12 mm;
an adhesive applied to a back surface of the set of indicia; and
a mounting material that is not one of either embossed or debossed upon which the set of indicia is mounted to generate an announcement device.

8. The announcement device of claim 7 herein the set of indicia has information related to at least one of either a wedding, a religious event, a social event, a business application, or a family event.

9. The announcement device of claim 8 wherein the non-embossed mounting material is made from a material selected from the group consisting of paper, cardstock, plastic stock, wood stock, metal, and leather.

10. The announcement device of claim 9 wherein at least one component of the set of indicia is a solid metal material.

11. The announcement device of claim 9 wherein at least one component of the set of indicia is not a solid metal material.
